(19) United States
(12) Patent Application Publication
(10) Pub. No.: US 2020/0285602 A1
(43) Pub. Date: Sep. 10, 2020

(54) eUSB2 to USB 2.0 Data Transmission with Surplus Sync Bits

(71) Applicant: Texas Instruments Incorporated, Dallas, TX (US)

(72) Inventors: Win Naing MAUNG, Plano, TX (US); Douglas Edward WENTE, Murphy, TX (US); James Mark SKIDMORE, Frisco, TX (US); Bharath Kumar SINGAREDDY, Bengaluru (IN); Suzanne Mary VINING, Plano, TX (US); Huanzhang HUANG, Plano, TX (US)

(21) Appl. No.: 16/747,719

(22) Filed: Jan. 21, 2020

Related U.S. Application Data
(60) Provisional application No. 62/813,777, filed on Mar. 5, 2019.
(60) Provisional application No. 62/954,428, filed on Dec. 28, 2019.

(51) Int. Cl. G06F 13/42

(52) U.S. Cl. CPC G06F 13/4295; G06F 2213/0042

(57) ABSTRACT

A system includes an eUSB2 transmitter, wherein the eUSB2 transmitter is configured to provide a data set comprising a data packet, default sync bits, and surplus sync bits. The system also includes an eUSB2 to USB 2.0 repeater coupled to the eUSB2 transmitter, wherein the eUSB2 to USB 2.0 repeater is configured to remove the surplus sync bits and to output the data packet and the default sync bits.

### CROSS-REFERENCE TO RELATED APPLICATIONS

This application claims priority to U.S. Provisional Application No. 62/813,777, filed Mar. 5, 2019, and U.S. Provisional Application No. 62/954,428, filed Dec. 28, 2019, which are hereby incorporated by reference.

### BACKGROUND

The proliferation of consumer electronic devices and integrated circuit (IC) technology has resulted in the commercialization of IC products. As new consumer electronic devices are developed and IC technology advances, new IC products are commercialized. To facilitate and guide commercialization efforts, many protocols have been and are being organized. Relevant examples include the Universal Serial Bus (USB) protocols, One of the more recent USB protocols developed is referred to as embedded USB (eUSB2).

In eUSB2, a high-speed repeating function is needed to meet a tight turn-around time to be ready to repeat packets in a eUSB2 to USB 2.0 direction after receiving a packet from a USB 2.0 to eUSB2 direction. This means that the USB 2.0 transmitter bias circuits need to be enabled and ready to transmit USB 2.0 packet without increasing jitter due to bias settling. The eUSB2 to USB 2.0 repeater has higher power than desired during high-speed mode since the transmitteron the receiving side is always enabled.

### SUMMARY

In accordance with at least one example of the disclosure, a system comprises an eUSB2 transmitter, wherein the eUSB2 transmitter is configured to provide a data set comprising a data packet, default sync bits, and surplus sync bits. The system also comprises an eUSB2 to USB 2.0 repeater coupled to the eUSB2 transmitter, wherein the eUSB2 to USB 2.0 repeater is configured to remove the surplus sync bits and to output the data packet and the default sync bits.

In accordance with at least one example of the disclosure, an eUSB2 transmitter comprises a differential transmitter and a phase-locked loop (PLL) coupled to the differential transmitter and configured to clock the differential transmitter. The eUSB2 transmitter also comprises a controller coupled to the differential transmitter, wherein the controller is configured to provide a data set to the differential transmitter, the data set comprising a data packet, default sync bits, and surplus sync bits.

In accordance with at least one example of the disclosure, an eUSB2 to USB 2.0 repeater comprises differential input nodes configured to receive a data set comprising a data packet, default sync bits, and surplus sync bits. The eUSB2 to USB 2.0 repeater also comprises a sync bit counter coupled to the differential input nodes. The eUSB2 to USB 2.0 repeater also comprises a differential transmitter coupled to the differential input nodes via buffer components. The sync bit counter is configured to enable the differential transmitter after counting a predetermined number of the surplus sync bits.

### BRIEF DESCRIPTION OF THE DRAWINGS

For a detailed description of various examples, reference will now be made to the accompanying drawings in which:

FIG. 1 is a block diagram showing an electronic device in accordance with some examples;

FIG. 2 is a diagram showing operations of an embedded USB (eUSB2) transmitter and an eUSB2 to USB 2.0 repeater in accordance with some examples;

FIG. 3 is a flowchart showing an eUSB2 transmitter method in accordance with some examples; and

FIG. 4 is a flowchart showing an eUSB2 to USB 2.0 repeater method in accordance with some examples.

### DETAILED DESCRIPTION

Disclosed herein are embedded USB (eUSB2) to USB 2.0 repeater topologies that account for and remove surplus sync bits in a data set. The data set is provided by an eUSB2 transmitter coupled to the eUSB2 to USB 2.0 repeater. In some examples, the eUSB2 to USB 2.0 repeater includes differential input nodes configured to receive a data set comprising a data packet, default sync bits, and surplus sync bits. The eUSB2 to USB 2.0 repeater also includes a sync bit counter coupled to the differential input nodes. The eUSB2 to USB 2.0 repeater also includes a differential transmitter coupled to the differential input nodes via buffer components, where the sync bit counter is configured to enable the differential transmitter after counting a predetermined number of the surplus sync bits.

In some examples, the eUSB2 to USB 2.0 repeater also includes a signal detector circuit coupled to the differential input nodes, wherein the signal detector circuit is configured provide a wake-up signal to the differential transmitter in response to detecting the data set. In some examples, the signal detector circuit also provides a wake-up signal to a bias circuit coupled to the differential transmitter, where the wake-up signal is provided to the bias circuit in response to detecting the data set. In some examples, the signal detector circuit comprises a buffer circuit configured to provide the wake-up signal based on detection of the data set. In some examples, the sync bit counter is configured to count at least 20 surplus sync bits before asserting an enable signal to the differential transmitter. In one example, the sync bit counter is configured to count 24-26 surplus sync bits before asserting an enable signal to the differential transmitter.

With the proposed eUSB2 to USB 2.0 repeater and a compatible eUSB2 transmitter that provides surplus sync bits, a bias circuit of the eUSB2 to USB 2.0 repeater has more time to be disabled or enter low-power mode when USB 2.0 is not actively transmitting. In this example, the surplus sync bits enable a wake-up signal to stabilize the bias circuit before a data set (sometimes referred to as a start-of-packet or “SOP”) is transmitted. Use of the surplus sync bits and waiting to transmit the data set while the bias circuit is stabilizing will reduce jitter.

The first part of the proposed surplus sync bit solution is to have an eUSB2 transmitter (e.g., the eDSPr or eUSPr of the eUSB2 transmitter) that is configured to transmit surplus sync bits (e.g., around 25 bits) to allow the eUSB2 to USB 2.0 repeater to detect the data set and to turn on the bias circuit to stabilize the differential transmitter of the eUSB2 to USB 2.0 repeater. In some examples, the eUSB2 to USB 2.0 repeater implements a counter so that the surplus sync bits of a data set from an eUSB2 transmitter will be counted before the USB 2.0 high-speed differential transmitter is enabled to start transmitting. This is needed to make sure the USB 2.0 TX SOP sequence is between 28 bits to 32 sync bits per USB 2.0 specification. Also, additional data sets (HS SOPs) that are sent from eUSB2 are effectively gated off so USB 2.0 TX SOP is within spec to ensure interoperability with Legacy USB 2.0 devices. To provide a better understanding, various eUSB2 to USB 2.0 repeater options, eUSB2 transmitter options, system options, and related methods are described using the figures as follows.

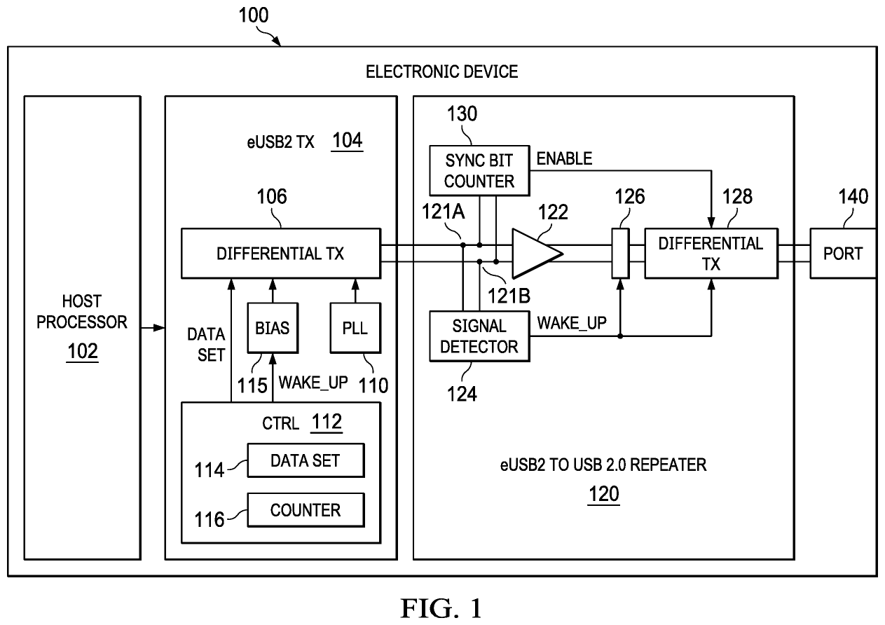

FIG. 1 is a block diagram showing an electronic device 100 in accordance with some examples. In different examples, the electronic device 100 corresponds to a consumer electronic device such as a smartphone, a tablet, a laptop computers, and/or another consumer electronic device. As shown, the electronic device 100 comprises a host processor 102 coupled to an eUSB2 transmitter 104. In some examples, the host processor 102 and/or the eUSB2 transmitter 104 are components of one or more systems on a chip (SoCs), where eUSB2 enables USB 2.0 interfaces to operate at input/output voltages of 1V or 1.2V instead of 3.3V.

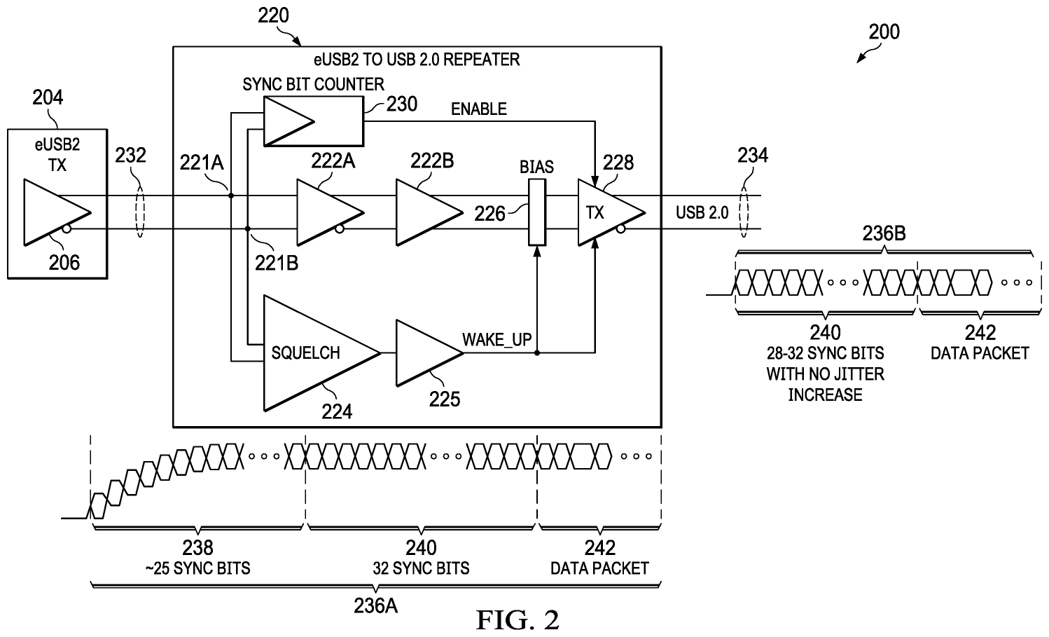

As shown, the eUSB2 transmitter 104 includes a differential transmitter 106 coupled to a phase-locked loop (PLL) 110, where the PLL 110 is configured to provide a clock signal to the differential transmitter 106. In operation, the differential transmitter 106 is configured to output a data set to an eUSB2 to USB 2.0 repeater 120, where the data set (e.g., an SOP) includes surplus sync bits, default sync bits, and a data packet. In some examples, the controller 112 provides the data set based on data set hardware or instructions 114, where the data set hardware or instructions 114 determine the number of surplus sync bits and default sync bits for the data set. In some examples, the data set hardware or instructions 114 provides data set information to the differential transmitter 106 to output a data set (e.g., the data set 236A in FIG. 2) with a data packet, default sync bits, and surplus sync bits. In some examples, the controller 112 includes a counter 116 to identify when a predetermined number of surplus sync bits and/or a predetermined number of default sync bits for the data set is counted. In some examples, the predetermined number of surplus sync bits is at least 20 (e.g., around 25), and the predetermined number of default sync bits is 28-32.

In some examples, the data set output by the eUSB2 transmitter 104 is generated based on commands from the host processor 102. In one example, the host processor 102 provides a command to the controller 112 to initiate or continue a transmission. In response, the controller 112 wakes-up any asleep components of the eUSB2 transmitter 104 that are needed (e.g., a bias circuit 115 coupled to the controller 112 and the differential transmitter 106 and configured to provide a bias current or voltage to the differential transmitter 106 as directed by the controller 112) and begins generating a next data set, where the next data set includes surplus sync bits, default sync bits, and a data packet. In one example, the bias circuit 115 for the differential transmitter 106 receives a wake-up signal from the controller 112 in response to a command from the host processor 102. After a wake-up interval to ensure stability of the bias circuit 115 and the differential transmitter 106, transmissions of a data set from the differential transmitter 106 commence. As needed, the process of generating a next data set is repeated. As desired, components of the eUSB2 transmitter 104 (e.g., at least the bias circuit 115) transition back and forth between an on-state and a low-power state between transmissions.

Each data set output from the eUSB2 transmitter 104 is received by the eUSB2 to USB 2.0 repeater 120. As shown, the eUSB2 to USB 2.0 repeater 120 includes differential input nodes 121A and 121B coupled to the eUSB2 transmitter 104. The eUSB2 to USB 2.0 repeater 120 also includes a sync bit counter 130 coupled to the differential input nodes 121A and 121B. The eUSB2 to USB 2.0 repeater 120 also includes a differential transmitter 128 coupled to the differential input nodes 121A and 121B via buffer components 122. In operation, the sync bit counter 130 is configured to enable (e.g., via an enable signal) the differential transmitter 128 after counting a predetermined number of the surplus sync bits. In some examples, the eUSB2 to USB 2.0 repeater 120 also includes a signal detector circuit 124 coupled to the differential input nodes 121A and 121B. The signal detector circuit 124 is configured provide a wake-up signal (or pre-enable signal) to the differential transmitter 128 in response to detecting the data set. In some examples, the eUSB2 to USB 2.0 repeater 120 also includes a bias circuit 126 coupled to the differential transmitter 128, where the signal detector circuit 124 is configured to provide a wake-up signal (or pre-enable signal) to the bias circuit 126 in response to detecting the data set. In some examples, the signal detector circuit comprises a buffer circuit (e.g., the squelch circuit 224 and the buffer circuit 225 in FIG. 2 are an example of the signal detector circuit 124 in FIG. 1) configured to provide the wake-up signal based on detection of the data set.

As described herein, the eUSB2 transmitter 104 is configured to provide at least 20 surplus sync bits. In some examples, the eUSB2 transmitter is configured to provide 28-32 default sync bits and at least 24 surplus sync bits. With the surplus sync bits, the bias circuit 126 and/or components of the differential transmitter 128 are disabled or enter low-power mode when USB 2.0 is not actively transmitting. When a data set needs to be transmitted, the surplus sync bits are counted and removed from the data set, which allows the wake-up signal from the signal detector circuit 124 to stabilize the bias for the differential transmitter 128 before the differential transmitter 128 transmits the data set without the surplus sync bits (i.e., the default sync bits and the data packet are transmitted). By waiting to send the data set until the bias circuit 126 has stabilized, jitter in the transmitted data set bits output from the differential transmitter 128 is reduced. In the example of FIG. 1, the output of the differential transmitter 128 is provided to a port 140 (e.g., with USB 2.0 compatibility).

As process nodes approach 5 nm, the manufacturing cost to maintain USB 2.0 input/output signaling at 3.3V has grown exponentially. The eUSB2 transmitter 104 and the eUSB2 to USB 2.0 repeater 120 address the input/output voltage gap as a physical layer supplement to the USB 2.0 specification so that designers can integrate the eUSB2 interface at the device level while leveraging and reusing the USB 2.0 interface at the system level. With the surplus sync bit solution, the eUSB2 transmitter 104 and the eUSB2 to USB 2.0 repeater 120 support low-power states for at least some components of the eUSB2 transmitter 104 and/or the eUSB2 to USB 2.0 repeater 120. In some examples, the eUSB2 transmitter 104 and the eUSB2 to USB 2.0 repeater 120 are part of an SoC with process nodes at 5 nm and below. eUSB2 can also be integrated into other devices, to easily interconnect with SoCs as a device-to-device interface, where USB 2.0 is used as the standard connector interface.

FIG. 2 is a diagram showing operations of an eUSB2 transmitter 204 (an example of the eUSB2 transmitter 104 in FIG. 1) and an eUSB2 to USB 2.0 repeater 220 (an example of the eUSB2 to USB 2.0 repeater 120 in FIG. 1) in accordance with some examples. In FIG. 2, a differential transmitter 206 of the eUSB2 transmitter 204 transmits a data set 236A, where the data set 236A includes surplus sync bits 238 (e.g., approximately 25 sync bits), default sync bits (e.g., 32 sync bits), and a data packet 242.

In some examples, the data set 236A output by the eUSB2 transmitter 204 is generated based on commands from a host processor (e.g., the host processor 102 in FIG. 1). In one example, a host processor provides a command to the eUSB2 transmitter 204 to initiate or continue a transmission. In response, the eUSB2 transmitter 204 wakes-up any asleep components that are needed and begins generating a next data set, where the next data set includes surplus sync bits, default sync bits, and a data packet. As needed, the process of generating a next data set is repeated.

Each data set (e.g., the data set 236A) output from the eUSB2 transmitter 204 is received by the eUSB2 to USB 2.0 repeater 220 via a signal line 232 between the eUSB2 transmitter 204 and the eUSB2 to USB 2.0 repeater 220. As shown, the eUSB2 to USB 2.0 repeater 220 includes differential input nodes 221A and 221B (an example of the differential input nodes 121A and 121B in FIG. 1) coupled to the eUSB2 transmitter 204. The eUSB2 to USB 2.0 repeater 220 also includes a sync bit counter 230 coupled to the differential input nodes 221A and 221B. The eUSB2 to USB 2.0 repeater 220 also includes a differential transmitter 228 coupled to the differential input nodes 221A and 121B via buffer components 222A and 222B (examples of the buffer components 122 in FIG). In operation, the sync bit counter 230 is configured to enable (e.g., via an enable signal) the differential transmitter 228 after counting a predetermined number of the surplus sync bits 238. In some examples, the eUSB2 to USB 2.0 repeater 220 also includes a squelch circuit 224 coupled to the differential input nodes 221A and 221B and configured to distinguish the data set 236A from noise. The output of the squelch circuit 224 is provided to a buffer circuit 225, which provides a wake-up signal (or pre-enable signal) to the differential transmitter 228 in response to the squelch circuit 224 detecting the data set 236A. In some examples, the squelch circuit 224 and the buffer circuit 225 correspond to components of a signal detect circuit (e.g., the signal detector circuit 124 in FIG. 1).

In some examples, the eUSB2 to USB 2.0 repeater 220 also includes a bias circuit 226 coupled to the differential transmitter 228, where the buffer circuit 225 is configured to provide a wake-up signal (or pre-enable signal) to the bias circuit 226 in response to the squelch circuit 224 detecting the data set 236A.

With the surplus sync bits 238, the bias circuit 226 and/or components of the differential transmitter 228 are disabled or enter low-power mode when USB 2.0 is not actively transmitting. When a data set (e.g., the data set 236A) needs to be transmitted, the surplus sync bits (e.g., the surplus sync bits 238) are counted and removed. In the example of FIG. 2, the removal of the surplus sync bits 238 from the data set 236A allows the wake-up signal the buffer circuit 225 to stabilize the bias for the differential transmitter 228 before the differential transmitter 228 transmits a data set 236B, which corresponds to the data set 236A without the surplus sync bits 238. By waiting to send the data set 236B until the bias circuit 226 has stabilized, jitter in the transmitted data set bits output from the differential transmitter 228 is reduced. In the example of FIG. 2, the output of the differential transmitter 228 is provided to a signal line 234 and/or subsequent port (e.g., with USB 2.0 compatibility).

With the eUSB2 transmitter 104 and eUSB2 to USB 2.0 repeater 120, the electronic device 100 supports low-power states for the at least some components of the eUSB2 transmitter 104 and/or the eUSB2 to USB 2.0 repeater 120. For example, as described herein, the surplus sync bits give a bias circuit 226 of the eUSB2 to USB 2.0 repeater 220 time to stabilize before the differential transmitter 228 is enabled to transmit a data set as described herein.

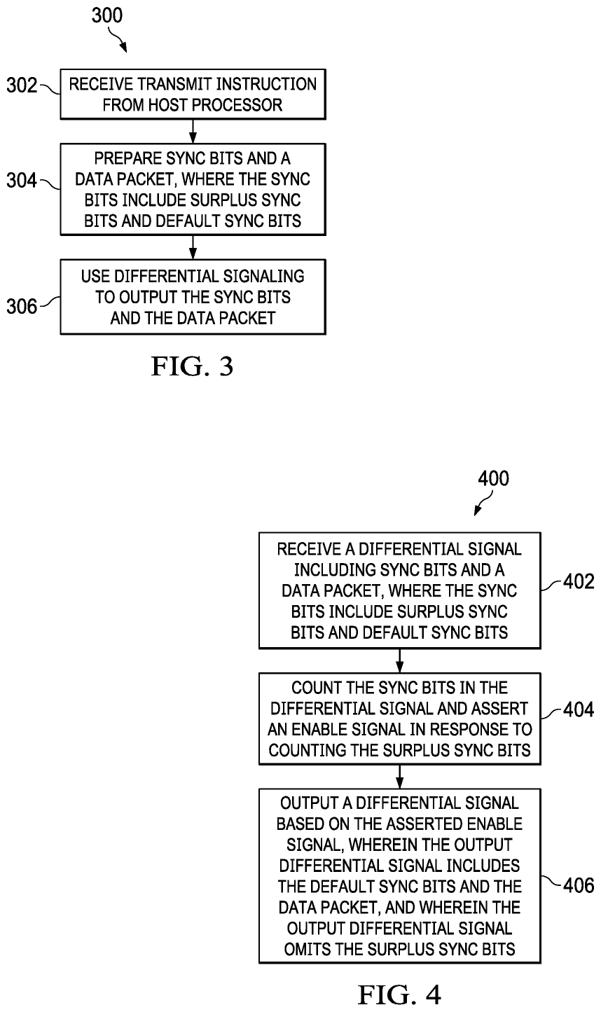

FIG. 3 is a flowchart showing an eUSB2 transmitter method 300 in accordance with some examples. The method 300 is performed, for example, by the eUSB2 transmitter 104 of FIG. 1, or the eUSB2 transmitter 204 of FIG. 2. As shown, the method 300 includes receiving a transmit instruction from a host processor (e.g., the host processor 102 in FIG. 1) at block 302. At block 304, sync bits and a data packet are prepared, where the sync bits include surplus sync bits and default sync bits. At block 306, differential signal is used to output the sync bits and the data packet. In some examples, the method 300 also includes transitioning at least some eUSB2 transmitter components from a low-power state to an on-state in response to receiving the transmit instruction from the host processor at block 302.

FIG. 4 is a flowchart showing an eUSB2 to USB 2.0 repeater method 400 in accordance with some examples. The method 400 is performed, for example, by the eUSB2 to USB 2.0 repeater 120 of FIG. 1, or the eUSB2 to USB 2.0 repeater 220 of FIG. 2. As shown, the method 400 includes receiving a differential signal including sync bits and a data packet, where the sync bits include surplus sync bits and default sync bits at block 402. At block 404, the sync bits in the differential signal are counted and an enable signal is asserted in response to counting the surplus sync bits, or a predetermined number of surplus sync bits. At block 406, a differential signal is output based on the asserted enable signal, wherein the output differential signal includes the default sync bits and the data packet, and wherein the output differential signal omits the surplus sync bits.

With the surplus sync bits in methods 300 and 400, a bias circuit (e.g., the bias circuit 126 in FIG. 1, or the bias circuit 226 in FIG. 2) and/or components of a differential transmitter (e.g., the differential transmitter 128 in FIG. 1, or the differential transmitter 228 in FIG. 2) are disabled or enter low-power mode when USB 2.0 is not actively transmitting. When a data set (e.g., the data set 236A in FIG. 2) needs to be transmitted, the surplus sync bits (e.g., the surplus sync bits 238 in FIG. 2) are counted and removed. With the methods 300 and 400, the removal of the surplus sync bits from a data set (e.g., the data set 236A) allows a wake-up signal from a signal detector circuit (e.g., the signal detector circuit 124 in FIG. 1, or the squelch circuit 224 and buffer circuit 225 in FIG. 2) to stabilize the bias for a differential transmitter (e.g., the differential transmitter 228 in FIG. 2) before the differential transmitter transmits a data set that includes default sync bits and a data packet while omitting the surplus sync bits. By waiting to send the data set until the bias circuit has stabilized, jitter in the transmitted data set bits output from a differential transmitter (e.g., the differential transmitter 228 in FIG. 2) is reduced. The differential signal output at block 406, is provided to a signal line (e.g., the signal line 234 in FIG. 2) and/or subsequent port (e.g., with USB 2.0 compatibility).

Certain terms have been used throughout this description and claims to refer to particular system components. As one skilled in the art will appreciate, different parties may refer to a component by different names. This document does not intend to distinguish between components that differ only in name but not in their respective functions or structures. In this disclosure and claims, the terms “including” and “comprising” are used in an open-ended fashion, and thus should be interpreted to mean “including, but not limited to . . . ”

The term “couple” is used throughout the specification. The term may cover connections, communications, or signal paths that enable a functional relationship consistent with the description of the present disclosure. For example, if device A generates a signal to control device B to perform an action, in a first example device A is coupled to device B by direct connection, or in a second example device A is coupled to device B through intervening component C if intervening component C does not alter the functional relationship between device A and device B such that device B is controlled by device A via the control signal generated by device A.

The above discussion is meant to be illustrative of the principles and various embodiments of the present invention. Numerous variations and modifications will become apparent to those skilled in the art once the above disclosure is fully appreciated.

What is claimed is:

1. A system, comprising:
an eUSB2 transmitter, wherein the eUSB2 transmitter is configured to provide a data set comprising a data packet, default sync bits, and surplus sync bits; and
an eUSB2 to USB 2.0 repeater coupled to the eUSB2 transmitter, wherein the eUSB2 to USB 2.0 repeater is configured to remove the surplus sync bits and to output the data packet and the default sync bits.

2. The system of claim 1, wherein the eUSB2 transmitter comprises:
a differential transmitter;
a phase-locked loop (PLL) coupled to the differential transmitter and configured to clock the differential transmitter; and
a controller coupled to the differential transmitter, wherein the controller is configured to provide the data packet, the default sync bits, and the surplus sync bits to the differential transmitter.

3. The system of claim 2, wherein the eUSB2 transmitter further comprises a bias circuit coupled to the controller and the differential transmitter, and wherein the bias circuit is configured to provide a bias voltage or current to the differential transmitter as directed by the controller.

4. The system of claim 3, further comprising a host processor coupled to the controller, wherein the controller is configured to send a wake-up signal to the bias circuit in response receiving a command from the host processor, and wherein the controller is configured to send the data set to the differential transmitter for transmission after a wake-up interval.

5. The system of claim 1, wherein the eUSB2 to USB 2.0 repeater comprises:
differential input nodes coupled to the eUSB2 transmitter;
a sync bit counter coupled to the differential input nodes; and
a differential transmitter coupled to the differential input nodes via buffer components,
wherein the sync bit counter is configured to enable the differential transmitter after counting a predetermined number of the surplus sync bits.

6. The system of claim 5, further comprising a signal detector circuit coupled to the differential input nodes, wherein the signal detector circuit is configured provide a wake-up signal to the differential transmitter in response to detecting the data set.

7. The system of claim 6, further comprising a bias circuit coupled to the differential transmitter, wherein the signal detector circuit is configured to provide a wake-up signal to the bias circuit in response to detecting the data set.

8. The system of claim 6, wherein the signal detector circuit comprises a buffer circuit configured to provide the wake-up signal based on detection of the data set.

9. The system of claim 1, wherein the eUSB2 transmitter is configured to provide at least 20 surplus sync bits.

10. The system of claim 1, wherein the eUSB2 transmitter is configured to provide 28-32 default sync bits and at least 24 surplus sync bits.

11. An eUSB2 transmitter, comprising:
a differential transmitter;
a phase-locked loop (PLL) coupled to the differential transmitter and configured to clock the differential transmitter; and
a controller coupled to the differential transmitter, wherein the controller is configured to provide data set information to the differential transmitter to output a data set comprising a data packet, default sync bits, and surplus sync bits.

12. The eUSB2 transmitter of claim 11, wherein the controller includes a counter configured to determine when the surplus sync bits reaches a predetermined number.

13. The eUSB2 transmitter of claim 11, further comprising a bias circuit coupled to the controller and the differential transmitter, wherein the bias circuit is configured to provide a bias voltage or current to the differential transmitter as directed by the controller.

14. The eUSB transmitter of claim 11, wherein the controller is configured to provide 28-32 default sync bits and at least 24 surplus sync bits.

15. An eUSB2 to USB 2.0 repeater, comprising:
differential input nodes configured to receive a data set comprising a data packet, default sync bits, and surplus sync bits;
a sync bit counter coupled to the differential input nodes; and
a differential transmitter coupled to the differential input nodes via buffer components,
wherein the sync bit counter is configured to enable the differential transmitter after counting a predetermined number of the surplus sync bits.

16. The eUSB2 to USB 2.0 repeater of claim 15, further comprising a signal detector circuit coupled to the differential input nodes, wherein the signal detector circuit is configured provide a wake-up signal to the differential transmitter in response to detecting the data set.

17. The eUSB2 to USB 2.0 repeater of claim 16, further comprising a bias circuit coupled to the differential transmitter, wherein the signal detector circuit is configured to provide a wake-up signal to the bias circuit in response to detecting the data set.

18. The eUSB2 to USB 2.0 repeater of claim 16, wherein the signal detector circuit comprises a buffer circuit configured to provide the wake-up signal based on detection of the data set.

19. The eUSB2 to USB 2.0 repeater of claim 15, wherein the sync bit counter is configured to count at least 20 surplus sync bits before asserting an enable signal to the differential transmitter.

20. The eUSB2 to USB 2.0 repeater of claim 15, wherein the sync bit counter is configured to count 24-26 surplus sync bits before asserting an enable signal to the differential transmitter.
